(19) United States
(12) Patent Application Publication
(10) Pub. No.: US 2017/0016272 A1
(43) Pub. Date: Jan. 19, 2017

(54) Asymmetric Thickness Laminate Glass Unit For Reducing The Transmission of Sound Energy Through A Window or Door Unit

(71) Applicant: Ply Gem Industries, Inc., Cary, NH (US)

(72) Inventor: Jacob L. Ferguson, Boones Mill, VA (US)

(73) Assignee: Ply Gem Industries, Inc.

(21) Appl. No.: 14/956,852

(22) Filed: Dec. 2, 2015

Related U.S. Application Data
(60) Provisional application No. 62/191,590, filed on Jul. 13, 2015.

(51) Int. Cl. E06B 5/20; E06B 3/677; E06B 3/66; E06B 3/67; E04B 1/82; E04B 1/86

(52) U.S. Cl. CPC E06B 5/205; E04B 1/8209; E04B 1/86; E06B 3/6612; E06B 3/6707; E06B 3/677

(57) ABSTRACT

Disclosed is an insulated glazed unit for use in a window or door of a building for reducing the transmission of sound energy there through. The insulated glazed unit comprises a plurality of glass panels each with a front face and a rear face and each of a distinct thickness. In a first embodiment at least one substantially uniform gap is disposed between at least two of the glass panels. At least one plastic film is disposed between the front face of a first glass panel and the rear face of a second glass panel forming a laminated unit. The asymmetric thickness laminated unit in combination with the at least one gap and at least one additional glass panel forms an insulated glazed unit capable of reducing the transmission of sound energy.

### RELATED APPLICATIONS

This application claims the benefit of priority of U.S. application Ser. No. 62/191,590 filed on Jul. 13, 2015.

### TECHNICAL FIELD

The present disclosure relates to an asymmetric thickness laminate within an insulated glazed unit for use in windows and doors for reducing the transmission of sound energy there through.

### BACKGROUND

Windows, whether in walls or in door units, permit a large amount of sound energy to pass through a building, compared with the solid walls and roofs. Existing methods for insulating windows and doors against sound transmission involve expensive, unattractive, and inconvenient modifications, such as adding windows on top of windows. Existing methods use lightweight materials that do not provide sufficient noise reduction in situations where traffic, aircraft, and other noises are occurring exterior to a building.

The acoustics industry makes soundproof window shopping easier by rating the sound-stopping quality of windows on a sound transmission class (STC) scale; the higher the number, the more a window inhibits sound. A single-pane window has an average STC rating of 27; a dual pane window has an average STC rating of 28. Until the windows have STC values in the 40s, the condition of the walls does not matter, as most walls have STC values in the 40s.

With the ever-increasing population density throughout the world, and especially in urban and suburban areas, an improved approach to sound reduction using window and door coverings is necessary. This disclosure details a system for sound reduction and absorption in an insulated glazed unit that allows for ease of manufacture that provides for quieter, more pleasant living, sleeping, and working environments within buildings.

### SUMMARY

Noise control is a rapidly growing economic and public policy concern for the construction industry. Areas with high acoustical isolation are requested and required for a variety of purposes. Apartments, condominiums, hotels, schools and hospitals all require rooms with doors, walls, ceilings and floors that reduce the transmission of sound thereby minimizing, or eliminating, the disturbance to people in adjacent rooms. Soundproofing is particularly important in buildings adjacent to public transportation, such as highways, airports and railroad lines. One measure of the severity of multi-family residential and commercial noise control issues is the widespread emergence of model building codes and design guidelines that specify minimum Sound Transmission Class (STC) ratings for specific wall and door structures within a building.

Comprehensive testing, according to a prescriptive ASTM standard, reveals that a one window system with a single panel window has an STC value range from 25-28. A typical dual pane window has an STC range from 26-30. A good dual pane window has an STC value range from 31-36 while a specialty noise abatement window has an STC value range from 38-47.

Accordingly, a need remains for a sound deadening window and door insulated glazed unit to reduce the transmission of sound from an exterior source to a building interior.

Various objects, features, aspects and advantages of the inventive subject matter will become more apparent from the following detailed description of preferred embodiments, along with the accompanying drawings in which like numerals represent like components. The contents of this summary section are provided only as a simplified introduction to the disclosure, and are not intended to be used to limit the scope of the appended claims.

The contents of this summary section are provided only as a simplified introduction to the disclosure, and are not intended to be used to limit the scope of the appended claims.

### BRIEF DESCRIPTION OF THE DRAWINGS

FIG. 1 illustrates sound energy emanating from passing traffic and impacting the windows of a structure;

FIG. 2 illustrates the absorption and reflection of sound energy impacting an asymmetric thickness laminate glass unit; and

FIG. 3 illustrates a cross sectional view of an embodiment of an asymmetric thickness laminate glass unit.

### DETAILED DESCRIPTION

Disclosed herein is a configuration for use in constructing an asymmetric laminated insulated glazed unit for sound blocking and absorbing in windows and doors that provides a significant improvement in the sound transmission class (STC) rating associated with the insulated glazed unit. In the preferred embodiment, a laminated structure is comprised of multiple layers of glass of varying thicknesses, referred to throughout this document as an asymmetric laminated insulated glazed unit. The term “asymmetric” is utilized in this context to convey that each of the glass layers employed in the laminate portion of the insulated glazed unit is of a varying thickness. The term “glass” as disclosed herein is intended to mean annealed as well as tempered glass and any vitreous material that is like glass in appearance or has physical properties comparable to glass. The panes of glass as noted immediately above are each of a different thickness ranging from about 2 to about 6 mm. The terms “panel” and “pane” as utilized in this disclosure are intended to mean glass formed into thin sheets.

In this preferred embodiment, a first glass layer of annealed glass is exposed to the exterior of the building. And two additional layers of glass of varying thicknesses are also employed in building the laminate glass unit. In addition, two or more of the previously mentioned glass layers are separated by a thin layer of polyvinyl butyral, or another engineered plastic, and other layers are separated by an air gap or gap filled with a low thermal conductivity gas, such as argon.

Sound ratings are typically based off of the Sound Transmission Class (STC) scale system. This single rating system enables a designer to match up architectural products that when combined will create an STC rating for the entire assembly controlling the noise and vibration in a room, office or even an entire building. The preferred method for determining the STC rating of a product is a test called the ASTM E-90. (Officially called the “Standard Method for Laboratory Measurement of Airborne Sound Transmission”). During an ASTM E-90 test, a test specimen is mounted between a room containing an isolated source of noise and a receiving room. Sound transmission loss, the difference between the sound level in the source room and the receiving room, is measured at specific sound frequencies and used to arrive at the STC rating. The higher the STC rating calculated, the quieter it is in the receiving room.

In addition to the ASTM test method discussed above, the Outdoor-indoor transmission class (OITC) is a standard used for indicating the rate of transmission of sound between outdoor and indoor spaces in a structure. It is based on the ASTM E-1332 Standard Classification for the Determination of Outdoor-Indoor Transmission Class. OITC utilizes a source noise spectrum that considers frequencies down to 80 Hz (Aircraft/Rail/Truck traffic) and is weighted more to lower frequencies. When OITC testing is performed on an insulated glazed unit the frames used with the insulated glazed unit can have a substantial impact upon the amount of sound energy that is transmitted through the glazed unit. Consequently, vendors of insulated glazed units often times will strive for uniformity in the frames employed during testing to provide a baseline against which to evaluate the capabilities of various glazed unit designs.

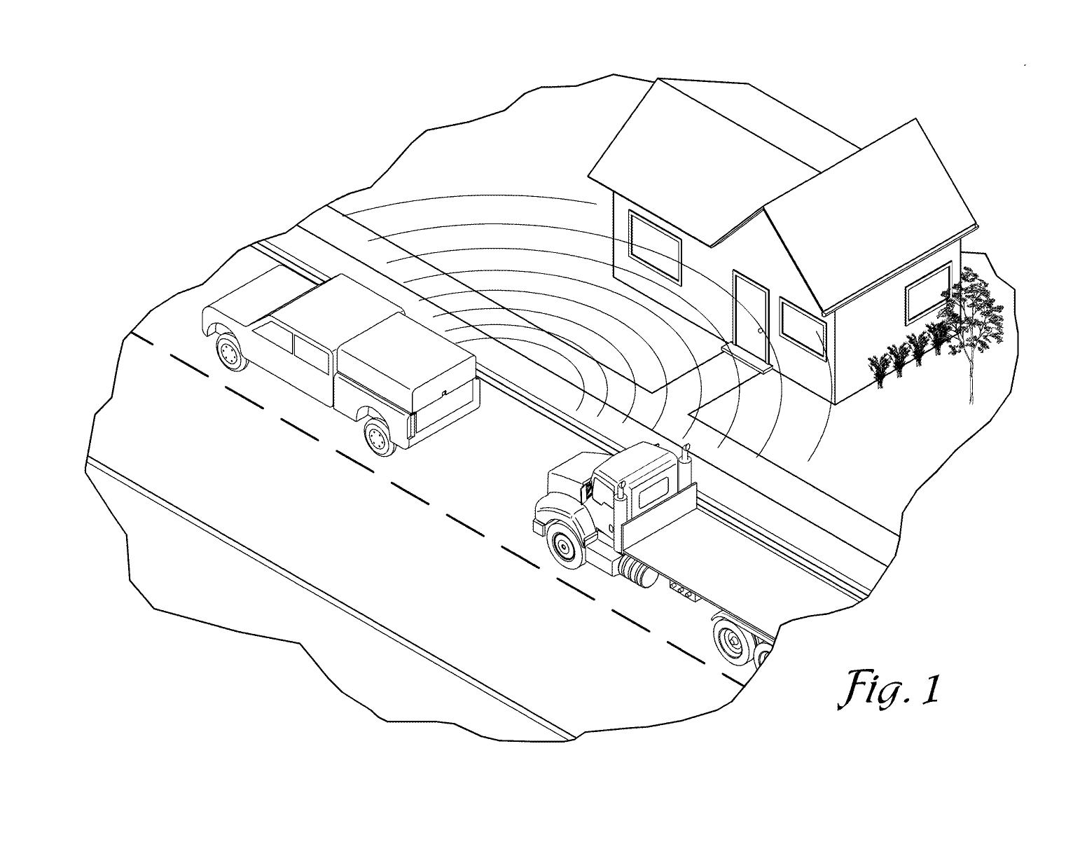

FIG. 1 illustrates a typical suburban setting with a home located proximate a busy roadway. The vehicles passing the home generate road noise due to the surface roughness of the roadway as well as engine noise, vehicle horns, radio noises, and even loud speech emanating from vehicle occupants. The sound wave travel toward the home and if of sufficient amplitude and correct frequency can pass through a typical single pane glass window.

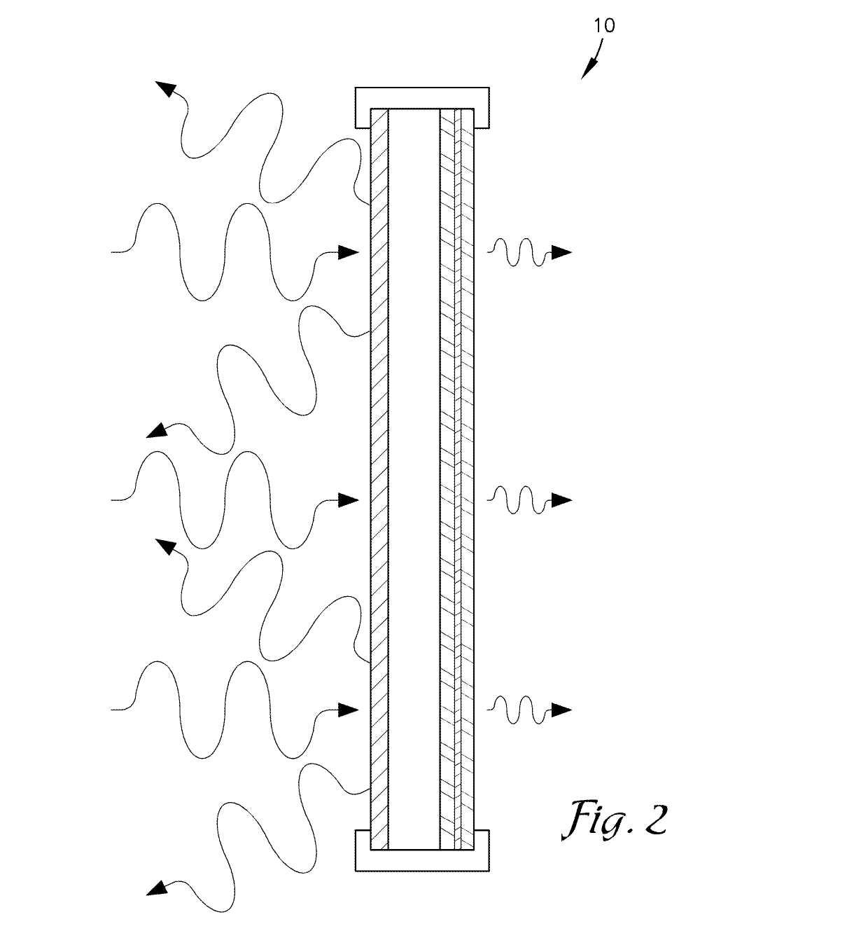

An embodiment of the disclosed technology is illustrated in FIG. 2 detailing how the sound energy impinging upon the disclosed embodiment is both substantially reflected and absorbed by the asymmetric thickness laminate glass unit.

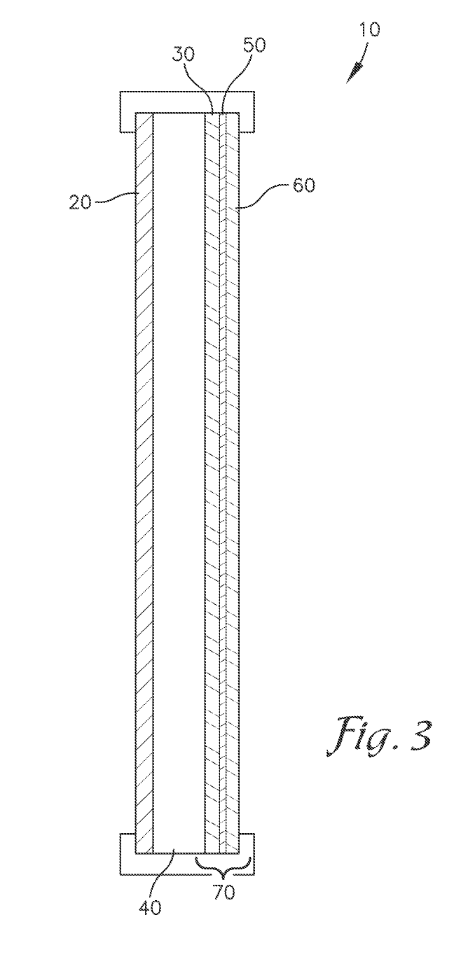

FIG. 3 details a preferred embodiment of the sound absorbing glass window unit 10. Beginning with the layer facing the exterior of the building, the first layer 20 of the asymmetric laminated insulated glazed unit is an annealed glass pane, preferably approximately 5 mm in thickness. Separating the first layer 20 from the second glass layer 30 is gap 40 of preferably about 9/16 inch. The gap 40 space is preferably filled with air, or an inert gas, such as argon or krypton to further lower the potential for transfer of sound energy. The second glass layer 30, across the gap 40 from the first layer 20 is preferably about 3.0 mm in thickness.

The sound energy exterior to the building must first travel through the exterior layer of glass 20, then the gap 40 and then through the second layer 30 of a different thickness. Adhered to the second glass layer 30, opposite the gap 40 is a polyvinyl butyral (PVB) layer 50. The PVB layer 50 is preferably about 0.030 inches in thickness and further reduces the transmission of vibrational energy from the second glass layer 30 to the third and final layer 60 of the insulated glazed unit 10 by mechanically isolating the glass layers of the laminate unit 70 so that they vibrate independently. As discussed above, the PVB layer 50 can be substituted with other engineered plastics or films comparable to PVB to accomplish the same goal to alter the substrate through which the sound must pass thereby disrupting the frequency at which the sound is being transmitted.

The third glass layer 60, which faces the interior of the structure, is preferably about 2.3 mm in thickness. The second 30 and third 60 glass layers sandwich the above referenced polyvinyl butyral layer 50 between the two glass panels. Each of the three glass panels, or layers, detailed above is of a different thickness. As noted above, it is the asymmetric nature of the glass panel arrangement that serves to enhance the sound retarding characteristics of the insulated glazed unit 10, more specifically the asymmetric thickness laminate. The combination of the second glass layer 30 the polyvinyl butyral film 50 and the third glass layer 60 are referred to in the above preferred embodiment as the laminate unit 70. The laminate unit 70 may preferably be pre-fabricated by a vendor as a stand-alone package and combined with additional glass panels in any number of unique combinations and thicknesses to optimize the reduction of the transfer of sound energy through the combined glass unit 10.

When tested according to ASTM E-90 the above described asymmetric laminated glass for sound blocking and absorbing in a window or door unit is capable of achieving a sound transmission class rating of about 33 to about 36. Testing has also shown that utilizing the disclosed asymmetric glass configuration along with the preferred gap between glazed asymmetric units and the use of a PVB layer can improve the STC rating by 2 to 3 points compared to symmetric laminated glass. When tested in accordance with the OITC method discussed above, the insulated glazed unit has a rating from about 28 to about 31.

An alternative embodiment of a laminated glass unit capable of reducing the transmission of sound energy includes first and second glass panels each with a front face and a rear face and each of a different thickness. The first and second glass panels are separated by at least one plastic film disposed between the rear face of the first glass panel and the front face of the second glass panel forming an asymmetric thickness laminated glass unit. A preferred embodiment of this asymmetric thickness laminated glass unit would include a first glass panel with a thickness equal to or greater than 2.0 mm and a second glass panel with a thickness in the range of from 2.0 to 8.0 mm. The plastic film in this embodiment of an asymmetric thickness laminated glass unit is comprised of an engineered plastic and preferably a film of polyvinyl butyral with a thickness in the range of from 0.010 inches to 0.090 inches.

Additional embodiments of laminated glass units capable of reducing the transmission of sound energy include the use of additional panels of different thickness either directly in contact with adjacent glass panels or alternatively separated by at least one layer of an engineered plastic. It is envisioned that the laminated glass units could incorporate many layers of glass of varying thicknesses to further degrade the sound energy that passes through the laminated glass unit.

The above described configuration is merely a preferred embodiment of the disclosed technology and numerous configurations of glass panels of varying thicknesses, PVB films and air gaps (to include noble gases) of various thicknesses and composition all tend to produce superior sound deadening capabilities over single and dual pane windows.

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I claim:

1. An insulated glazed unit for use in a window or door for reducing the transmission of sound energy, the insulated glazed unit comprising:
at least three glass panels each with a front face and a rear face and each of a different thickness;
at least one substantially uniform gap disposed between a first and a second of the at least three glass panels;
at least one plastic film disposed between the rear face of the second glass panel and the front face of the third glass panel forming a laminated unit, wherein the laminated unit in combination with the at least one gap and the first glass panel forms an insulated glazed unit capable of reducing the transmission of sound energy there through.

2. The insulated glazed unit of claim 1, wherein each of the different thickness glass panels range in thickness from about 2 mm to about 8 mm.

3. The insulated glazed unit of claim 1, wherein the at least one substantially uniform gap disposed between the first and second glass panels is in the range of from about 5 mm to about 25 mm.

4. The insulated glazed unit of claim 1, wherein the plastic film is comprised of an engineered plastic.

5. The insulated glazed unit of claim 1, wherein the plastic film thickness is in the range from 0.254 mm to 2.29 mm.

6. The insulated glazed unit of claim 1, wherein the insulated glazed unit has a sound transmission class (STC) rating greater than 31 when tested in accordance with ASTM E 90 and E 413.

7. The insulated glazed unit of claim 1, wherein the insulated glazed unit has an Outdoor-Indoor Transmission Class (OITC) rating greater than 28 when tested in accordance with ASTM E 1332 and E 2235.

8. An asymmetric insulated glazed unit for use in a window or door of a building for reducing the transmission of sound energy, the asymmetric glass laminated insulated glazed unit comprising:
a first layer of glass facing an exterior of the building;
a second layer of glass with a front face and a back face, and a thickness different than the first layer, the second layer separated from the first layer by a substantially uniform gap;
a film of plastic with a front face and a back face, the front face in direct contact with back face of the second glass layer;
a third layer of glass with a thickness different from the thickness of the first and second layers of glass, the third layer facing an interior of a building, the third layer further comprising a front face and a back face, wherein the front face is in contact with the back face of the film of plastic and the glazed unit is capable of achieving a sound transmission class rating greater than 31 when tested in accordance with ASTM E-90.

9. (canceled)

10. The asymmetric laminated insulated glazed unit of claim 8, wherein the first layer is comprised of glass with a thickness equal to or greater than 2.0 mm.

11. The asymmetric laminated insulated glazed unit of claim 8, wherein the substantially uniform gap between the first and second glass layers is in the range of from 5 to 25 mm.

12. The asymmetric laminated insulated glazed unit of claim 8, wherein the substantially uniform gap between the first and second glass layers is filled with at least one of air or an inert gas.

13. The asymmetric laminated insulated glazed unit of claim 8, wherein the second glass layer has a thickness in the range of from 2.0 to 8.0 mm.

14. The asymmetric laminated insulated glazed unit of claim 8, wherein the third glass layer has a thickness in the range of from 2.0 to 8 mm.

15. The asymmetric laminated insulated glazed unit of claim 8, wherein the film of plastic has a thickness in the range of from 0.25 mm to 2.29 mm.

16. (canceled)

17. (canceled)

18. (canceled)

19. (canceled)

20. (canceled)
